(19) United States
(12) Patent Application Publication
(10) Pub. No.: US 2009/0223974 A1
(43) Pub. Date: Sep. 10, 2009

(54) Container for storing liquefied gas

(76) Inventor: Tanno Maarten Felius, The Hague (NL)

Correspondence Address: SHELL OIL COMPANY, P O BOX 2463, HOUSTON, TX, 772522463, US

(21) Appl. No.: 11/631,568

(22) PCT Filed: Jul. 4, 2005
(86) PCT No.: PCT/EP05/53165

§ 371 Date: Jan. 3, 2007

(30) Foreign Application Priority Data
Jul. 6, 2004 (EP) 042554047.6

(51) Int. Cl. F17C 3/04

(52) U.S. Cl. 220/560.12

(57) ABSTRACT

The present invention relates to a thermally insulated container (1) for storing liquefied gas (80). The container (1) comprises: a load bearing structural outer shell (2); a continuous first liquid barrier (40), during use being in contact with the liquefied gas (80); a first thermally insulating panel layer (11); a second liquid barrier (20); a second thermally insulating panel layer (10); first connectors (35) for connecting the first panel layer (11) to one of the second panel layers (10); second connectors (15) for connecting at least one of the second panel layers (10) to the outer shell (2); wherein the first panel layer (11) and at least one of the second panel layers (10) comprise through going passages for partially receiving the first and second connectors (35, 15).

The present invention relates to a thermally insulated container for storing a liquefied gas, such as liquefied natural gas (LNG), liquefied nitrogen, oxygen or carbon dioxide or liquefied hydrogen. Suitably the liquefied gas is stored in the container at atmospheric pressure.

Several kinds of thermally insulated containers are known from practice. Usually, a container contains a structural outer shell, an inner tank to contain the liquefied gas (and any vapours) and insulation provided between the structural outer shell and the inner tank to reduce the leakage of heat into the interior of the container.

Usually, to be able to contain the cold liquefied gas, the structural outer shell of such a container is made from a special material such as nickel steel or pre-stressed reinforced concrete.

An example of a thermally insulated container is given in U.S. Pat. No. 3,112,043. U.S. Pat. No. 3,112,043 discloses a ship for transporting liquefied gases at about atmospheric pressure. The ship is provided with a rigid shell as an inner hull, the rigid shell being internally lined with heat-insulating material. In the space enclosed by the heat-insulated rigid shell inner tanks, made from aluminium or stainless steel, are present. The inner tanks contain the cold liquid and the vapours.

A problem of the known containers for storing liquefied gas is that they are usually heavy, as they contain a substantial amount of metal. Further the used metal (e.g. nickel steel) is usually from a very high quality, as a result of which the containers are expensive.

A further problem is that it is time-consuming to construct the known containers as the metallic containment layers must be welded. This problem is even more pertinent if a material such as nickel steel is used, as this material is difficult to weld and requires experienced welding personnel.

It is an object of the present invention to minimize the above problems.

It is a further object to provide a safe but light-weight container for storing liquefied gas that can be constructed easily and quickly.

One or more of the above or other objects is achieved according to the present invention by providing a thermally insulated container for storing liquefied gas, the container at least comprising:

a load bearing structural outer shell;

on the inside of the outer shell a continuous first liquid barrier, the first liquid barrier during use being in contact with the liquefied gas;

between the first liquid barrier and the structural outer shell a first thermally insulating panel layer, the first panel layer having a front face facing the interior of the container and a back face;

between the first panel layer and the outer shell a second liquid barrier;

between the second liquid barrier and the outer shell at least one second thermally insulating panel layer, the second panel layer having a front face facing the interior of the container and a back face;

first connectors for connecting the first panel layer to one of the second panel layers;

second connectors for connecting at least one of the second panel layers to the outer shell;

wherein the first panel layer and at least one of the second panel layers comprise through going passages for partially receiving and anchoring the first and second connectors;
wherein at least one of the second panel layers comprises anchor openings in the front face for partially receiving the first connectors;
wherein in the at least one second panel layer no fluid contact exists between on the one hand the through going passages for partially receiving the second connectors and on the other hand the anchor openings for partially receiving the first connectors.

According to the invention it has been surprisingly found that a light-weight container for storing and transporting liquefied gases can be provided that is easy and in an economic way to construct.

An important advantage of the container according to the present invention is that the container is leak free. Even in the unlikely event that the first panel layer would leak, the second liquid barrier will withstand the leaked-through fluid (i.e. liquid or vapour), as there is no fluid communication between on the one hand the through going passages for partially receiving the second connectors and on the other hand the anchor openings for partially receiving the first connectors.

Preferably, the container is substantially metal-free. To this end both the outer shell as well as the thermally insulating panel layers, liquid barriers and connectors are preferably made from a material other than metal. It goes without saying that in the latter case still some metallic connecting means may be present.

The outer shell may be made from any material suitable as a load barrier. Examples are metal, concrete, etc. As mentioned above it is preferably made from a cheap, non-metallic material.

The first and second liquid barriers are usually made from liquid- and vapour-tight materials. Preferably the first and second liquid barriers comprise a plastic material such as polyurethane or epoxy or a combination thereof. If desired, the liquid barriers may be reinforced, e.g. by incorporation of glass fibers. Usually, the liquid barriers are thinner than the panel layers and have a thickness of about 3-8 mm. Of course, other thicknesses may be used.

The first liquid barrier is a continuous layer, the second layer usually also is. To that end the liquid barriers may e.g. be applied by spray coating or the like. Of course, the coating may also be applied by using a brush or a trowel.

The first and second panel layers are made from panels of a thermally insulating material. Preferably the first and second panel layers comprise foamed plastic material. Preferably the first and second panel layers are made from a plastic material that can withstand the load of the liquefied gas contained in the container. Suitable examples of the plastic material are PVC and polyurethane foam. The material used preferably can also resist the pneumatic pressure of the liquefied gas stored in the container.

Suitably the first and second panel layers have a thickness of at least 5 cm.

The first and second connectors may have various forms. Preferably the connectors are made from a non-metallic material. Usually, the connectors are studs. Preferably, the stud is provided with a screw thread, to easily fix the stud in the anchor openings of the one or more second panel layers. If only one second panel layer is present, the second connectors provide the connection between the second layer and the outer shell; the outer shell will then comprise anchor openings to partially receive the second connectors.

Preferably the second panel layer is directly fixed to the outer shell. It is even more preferred that no empty spaces are present between the first liquid barrier and the outer shell, whereby the container can be constructed as small as possible for a given liquefied gas storage volume.

Further it is preferred that the through going passages in the first panel layer and at least one of the second panel layers comprise recesses at the front sides of the respective panel layers. These recesses function to at least partially receive any washers, nuts or the like being present to fix those ends of the connectors being at the front sides of the panels. As a result the liquid barrier applied on the respective front side may be substantially planar.

Also it is preferred that the recesses have been filled with insert pieces. Further it is preferred that the insert pieces have been fixed in the respective recesses by use of an adhesive. The insert pieces—that may have any suitable form—may contribute in making the front side of the respective panel layer substantially planar.

Hereafter the invention will be further illustrated with reference to the following non-limiting drawings. Herein shows:

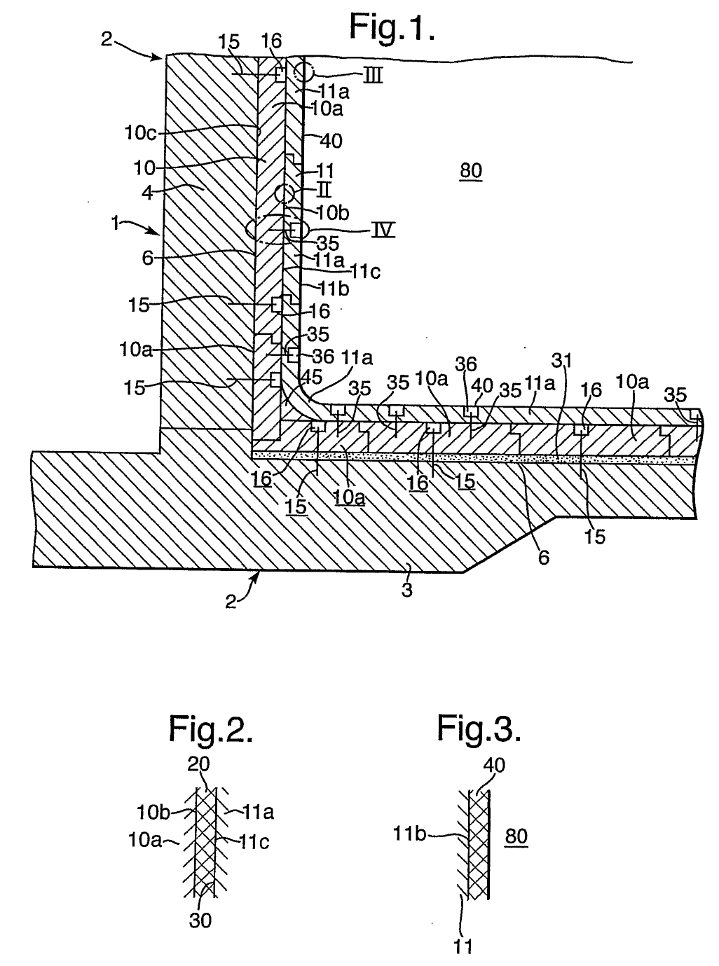

FIG. 1 schematically a lower corner of a thermally insulated container for storing liquefied gas constructed according to the present invention;

FIG. 2 detail II of FIG. 1 on a larger scale;

FIG. 3 detail III of FIG. 1 on a larger scale; and

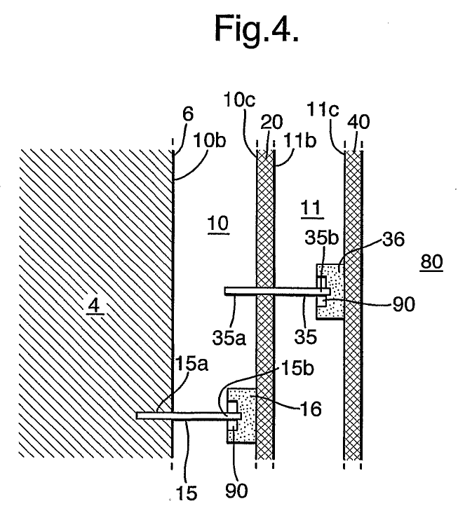

FIG. 4 detail IV of FIG. 1 on a larger scale.

The same reference numbers refer to similar structural elements.

Reference is now made to FIG. 1. The invention provides a thermally insulated container 1 for storing liquefied gas 80, which container 1 comprises a load bearing structural outer shell 2. The structural shell 2 comprises a base plate 3 and a side wall 4. In the example shown in the drawing the base plate 3 and the side wall 4 are made of concrete. The structural shell 2 has an inner surface 6. For the sake of completeness it is observed that the container 1 includes a roof (not shown) that is insulated and can form a part of the structural shell 2.

The container 1 further includes at least two thermally insulating containment layers, i.e. first panel layer 11 (‘inner containment layer’) and second panel layer 10 (‘outer containment layer’), which are secured to the inner surface 6 of the structural shell 2. It goes without saying that more than one outer containment layers 10 may be present, if desired.

Each containment layer 10 and 11 includes panels of a foamed plastics material having a front face facing the interior of the container 1 and a back face. The panels of the outer containment layer 10 are referred to with reference numerals 10a, their front faces with reference numeral 10b and their back faces with 10c. The panels of the inner containment layer 11 are referred to with reference numerals 11a, their front faces with 11b and their back faces with 11c. For the sake of clarity not all faces of the panels 10a and 11a are referred to with a reference numeral.

Further the container 1 comprises two vapour- and liquid-tight barriers, viz. a first liquid barrier 40 being in contact with the liquefied gas 80 contained in the container 1 (see also FIG. 3) and a second liquid barrier 20 between the inner containment layer 11 and outer containment layer 10 (see also FIG. 2).

Further the container 1 comprises first connectors 35 such as studs for connecting the inner containment layer 11 to the outer containment layer 10 and second connectors 15 such as studs for connecting the outer containment layer 11 to the outer shell 2.

To be able to receive the studs 35,15 the inner containment layer 11 and outer containment layer 10 are provided with through going passages (not shown). Further the outer containment layer 10 and the outer shell are provided with anchor openings (not shown) to receive those parts of the studs 15,35 being faced away from the interior and thereby fixing the inner containment layer 11, the outer containment layer 10 and the outer shell 2 to one another.

An important advantage of the container 1 according to the present invention is that the container 1 is leak free and vapour tight. Further, the outer shell 2 of the container 1 will not be exposed to low temperatures; as a result the material selection of the outer shell 2 of the container 1 is less stringent and thus more economical. Even in the unlikely event that the first liquid barrier 40 would leak, the second liquid barrier 20 will withstand the leaked-through fluid, as there is no fluid communication between on the one hand the through going passages for partially receiving and anchoring the second studs 15 and on the other hand the anchor openings for partially receiving the first studs 35.

To this end, the second liquid barrier 20 preferably has been fixed (e.g. by spraycoating) to the outer containment layer 10 in such a way that the second liquid barrier 20 cannot be removed from the outer containment layer 10 without destroying the layers. Preferably, the same applies for the first liquid barrier 40 and the inner containment layer 11.

Further the container 1 is substantially metal-free (the studs 15, 35 may be made from metal, although they may also be made from a plastic material) resulting in a light-weight container.

An exemplary and non-limiting method of constructing the thermally insulated container 1 for storing liquefied gas 80 comprising the containment layers 10 and 11 secured to the inner surface 6 of the structural shell 2 is discussed hereafter.

The first step of the method is providing the inner surface 6 of the structural shell 2 with a plurality of second connectors 15 such as studs. The studs 15 are aligned in mutually perpendicular directions and the distance between adjacent studs 15 is preferably so selected that there are at least two studs 15 available to secure one panel 10a. A way of providing the inner surface 6 with the studs 15 comprises placing anchor openings such as receiving nuts (not shown) provided with suitable protective covers in the setting concrete of the outer shell 2, and to use (preferably threaded) studs 15 of which the ends can be fixed in any suitable manner (e.g. glued, screwed or using expansion bolts or the like) into the receiving nuts.

Subsequently a layer of adhesive (not shown) may be deposited on the inner surface 6 of the structural shell 2. The panels 10a are provided with one through going passage (not shown) per stud 15. The passage extends from the back face 10c to a cylindrical recess 16 in the front face 10b. For the sake of clarity not all recesses 16 have been referred to with a reference numeral. These panels 10a are put in position. They are joined to the structural shell 2 by applying fixing means (e.g. fixing ring 90 in FIG. 4) to the ends of the studs 15 in the recesses 16 and by allowing the adhesive on the inner surface 6 to set.

Then the front faces 10b of the panels 10a outer containment layer 10 are provided with a plurality of studs 35. The studs 35 are also aligned in mutually perpendicular directions, wherein the distance between adjacent studs 35 is preferably so selected that there are at least two studs 35 available to secure one panel 11a.

A way of providing the front faces 10b with the studs 35 comprises placing anchor openings such as receiving nuts (not shown) provided with suitable protective covers in the panels 10a when they are manufactured, and to use threaded studs of which the ends can be screwed into the receiving nuts. Preferably the first studs 35 are not in a direct line with the second studs 15 to enhance liquid and vapour tightness and to avoid thermal bridges through the insulation panels.

After having placed the studs 35, a continuous vapour- and liquid-tight barrier 20 is provided on the front faces 10b of the panels 10a to obtain the outer containment layer 10. In this way a fluid-tight connection is made around the studs 35, the receiving nuts (not shown) and the surrounding outer containment layer 10. The barrier 20 is shown more clearly in FIG. 2.

In order to apply the second liquid barrier 20 it is preferred that the surface on which it is applied is smooth. However, the front faces 10b of the panels 10a are not smooth (there are recesses 16). Therefore, suitably, pre-fabricated foam insert pieces (not shown) are inserted in the recesses so as to create a smooth continuous surface on the front faces 10b of the panels 10a.

Thus the outer containment layer 10 comprises panels 10a that are secured to the inner surface 6 of the structural shell 2, and a continuous vapour- and liquid-tight barrier 20. The inner surface of the outer containment layer 10 is referred to with the reference numeral 30 (see FIG. 2).

Then a layer of adhesive (not shown) may be deposited on the inner surface 30 of the outer containment layer 10. The panels 11a are provided with one passage (not shown) per stud. The passage extends from the back face 11c to a cylindrical recess 36 in the front face 11b. For the sake of clarity not all recesses 36 have been referred to with a reference numeral. These panels 11a are put in position. They are joined to the structural shell 2 via the outer containment layer 10 by applying fixing means (e.g. a fixing ring 90 as shown in FIG. 4) to the ends of the studs 35 in the recesses 36 and by allowing the adhesive on the inner surface 30 to set.

Then a continuous vapour- and liquid-tight barrier 40 is provided on the front faces 11b of the panels 11a.

In order to apply the barrier 40 it is preferred that the surface on which it is applied is smooth. However, the front faces 11b of the panels 11a are not smooth (there are recesses 36). Therefore, suitably, pre-fabricated foam insert pieces (not shown) are inserted in the recesses 36 so as to create a smooth continuous surface on the front faces 11b of the panels 11a.

Thus the inner containment layer 11 consists of panels 11a that are secured to the inner surface 6 of the structural shell 2, and a continuous vapour- and liquid-tight barrier 40.

Suitably the panels 11a of the inner containment layer are staggered with respect to the panels 10a of the outer containment layer so that the panels 11a overlap the recesses 16 of the panels 10a.

Suitably, the panels 11a of the inner containment layer 11 at corners (i.c. at the bottom) of the container 1 are curved, and these panels 11a are supported by supporting corner pieces 45. In the embodiment of FIG. 1, wherein a cylindrical LNG storage container 1 is shown, the corner pieces 45 typically form an annular ring having a curved inner surface. The person skilled in the art will readily understand that these panels 11a placed at corners of the container 1 as well as the corner pieces 45 may have other suitable shapes, if desired.

The inner containment layer 11 is, during normal operation into contact with the liquefied gas stored in the thermally insulated container 1 according to the present invention.

Suitably the panels 10a and 11a are made of a suitable foam, preferably polyvinyl chloride or polyurethane foam, and the panels are covered by a polymer skin. To reduce the chances on leaking, the panels 10a and 11a have stepped side surfaces for shiplap engagement of the panels.

FIGS. 2, 3 and 4 show details II, III and IV of FIG. 1 on a larger scale, respectively. For the sake of clarity the presence of a second stud 15 has also been shown in FIG. 4, although FIG. 1 does not suggest that detail IV (i.e. FIG. 4) contains one.

As can be seen in FIG. 4, the anchor opening in the front face 10c of the outer containment layer 10 is filled by the end 35a of the first stud 35 being faced away from the interior of the container 1; thus the anchor opening in the outer containment layer 10 partially receives the first stud 35. Preferably both the anchor opening in the outer containment layer 10 as well as the end 35a of the stud 35 are provided with a screw thread (not shown).

Similarly, as shown in FIG. 4, the side wall 4 of the outer shell 2 also comprises an anchor opening which is filled by the end 15a of the second stud 15, the end 15a being faced away from the interior of the container 1.

The through going passage in inner containment layer 11 is for a part filled by the first stud 35 and for a part formed by the recess 36. The first stud 35 is fixed at the end 35b facing the interior of the container 1 by a fixing ring 90. The first stud 35 may be further fixed by an adhesive that is filled in the recess 36 of the inner containment layer 11. Further, if desired, an insert piece (not shown) may have been provided in the recess 36. This insert piece may have been pre-shaped or may be formed in situ, e.g. from a foamed material.

The person skilled in the art will readily understand that the container 1 according to the present invention can be varied widely without departing from the scope of the appended claims.

As an example, the inner surface 6 of the structural shell 2 can be provided with an additional continuous vapour barrier (not shown). This additional vapour barrier is then applied after the second studs 15 are provided. Then the first step of the method comprises providing the plurality of studs 15, and subsequently providing the inner surface 6 of the structural shell 2 with a vapour barrier (not shown).

In addition a protective levelling layer 31 can be laid on the base plate 3 before the panels 10a of the outer containment layer are placed on the base plate 3. The protective layer 31 may be made of e.g. dry sand or levelling concrete.

Also, the panels 10a and 11a may be shaped such that the front faces 10b and back faces 11c form channels at selected points between the layers 10 and 11 e.g. for facilitating purging with inert gas before commissioning or decommissioning of the container 1. These channels may further be used during use of the container 1 to monitor the liquid and vapour tightness of the liquid barriers 20 and 40.

The invention provides a surprisingly simple thermally insulated container that can be constructed in a quick an economic way. The container can be constructed as large cylindrical land containers, but it can also be constructed in the form of prismatic containers that are applied on vessels or on gravity-based structures. In addition, the present invention allows constructing containers that have the size of a freight container. The latter containers filled with liquefied gas can easily and safely be transported to any location where the gas can be used.

1. A thermally insulated container for storing liquefied gas, the container comprising:
a load bearing structural outer shell;
on the inside of the outer shell a continuous first liquid barrier, the first liquid barrier during use being in contact with the liquefied gas;
between the first liquid barrier and the structural outer shell a first thermally insulating panel layer, the first panel layer having a front face facing the interior of the container and a back face;
between the first panel layer and the outer shell a second liquid barrier;
between the second liquid barrier and the outer shell at least one second thermally insulating panel layer, the second panel layer having a front face facing the interior of the container and a back face;
first connectors for connecting the first panel layer to one of the second panel layers;
second connectors for connecting at least one of the second panel layers to the outer shell;
wherein the first panel layer and at least one of the second panel layers comprise through going passages for partially receiving the first and second connectors;
wherein at least one of the second panel layers comprises anchor openings in the front face for partially receiving the first connectors;
wherein in the at least one second panel layer no fluid contact exists between on the one hand the through going passages for partially receiving the second connectors and on the other hand the anchor openings for partially receiving the first connectors;
wherein the first and second panel layers comprise foamed plastic material.

2. The container according to claim 1, wherein the first and second liquid barriers comprise plastic material.

3. The container according to claim 1, wherein the first and second panel layers can withstand the load of the liquefied gas contained in the container.

4. The container according to claim 1, wherein the first and second panel layers have a thickness of at least 5 cm.

5. The container according to claim 1, wherein the panels of the first panel layer have been positioned in a staggered relationship with respect to the panels of the second panel layer.

6. The container according to claim 1, wherein at least one of the second panel layers is directly fixed to the outer shell.

7. The container according to claim 1, wherein the through going passages in the first panel layer and at least one of the second panel layers comprise recesses at the front sides of the respective panel layers.

8. The container according to claim 7, wherein the recesses have been filled with insert pieces.

9. The container according to claim 8, wherein the insert pieces have been fixed in the respective recesses by use of an adhesive.

10. The container according to claim 2, wherein the first and second panel layers can withstand the load of the liquefied gas contained in the container.

11. The container according to claim 2, wherein the first and second panel layers have a thickness of at least 5 cm.

12. The container according to claim 3, wherein the first and second panel layers have a thickness of at least 5 cm.

13. The container according to claim 2, wherein the panels of the first panel layer have been positioned in a staggered relationship with respect to the panels of the second panel layer.

14. The container according to claim 3, wherein the panels of the first panel layer have been positioned in a staggered relationship with respect to the panels of the second panel layer.

15. The container according to claim 4, wherein the panels of the first panel layer have been positioned in a staggered relationship with respect to the panels of the second panel layer.

16. The container according to claim 2, wherein at least one of the second panel layers is directly fixed to the outer shell.

17. The container according to claim 3, wherein at least one of the second panel layers is directly fixed to the outer shell.

18. The container according to claim 4, wherein at least one of the second panel layers is directly fixed to the outer shell.

19. The container according to claim 5, wherein at least one of the second panel layers is directly fixed to the outer shell.

20. The container according to claim 2, wherein the through going passages in the first panel layer and at least one of the second panel layers comprise recesses at the front sides of the respective panel layers.
